(19) United States
(12) Patent Application Publication
(10) Pub. No.: US 2025/0205951 A1
(43) Pub. Date: Jun. 26, 2025

(54) CONTROL DEVICE FOR INJECTION MOLDING MACHINE, INJECTION MOLDING MACHINE, AND CONTROL METHOD FOR INJECTION MOLDING MACHINE

(71) Applicant: SUMITOMO HEAVY INDUSTRIES, LTD., Tokyo (JP)

(72) Inventor: Jia Jie LEE, Chiba (JP)

(21) Appl. No.: 18/944,575

(22) Filed: Nov. 12, 2024

(30) Foreign Application Priority Data
Dec. 25, 2023 (JP) 2023-217608

(51) Int. Cl. B29C 45/78

(52) U.S. Cl. CPC B29C 45/78; B29C 2945/7604; B29C 2945/7614; B29C 2945/76311; B29C 2945/76531

(57) ABSTRACT

A control device for an injection molding machine configured to fill a cavity space inside a mold device with a molding material includes a memory, a processor coupled to the memory, and a temperature regulator controller configured to control a temperature regulator configured to regulate a temperature of the mold device. The temperature regulator controller controls the temperature regulator based on a dew point temperature of a surface of the mold device, the surface forming the cavity space in the mold device.

### CROSS-REFERENCE TO RELATED APPLICATIONS

Priority is claimed to Japanese Patent Application No. 2023-217608, filed Dec. 25, 2023, the entire content of which is incorporated herein by reference.

### BACKGROUND

### 1. Technical Field

The present disclosure relates to a control device for an injection molding machine, an injection molding machine, and a control method for the injection molding machine.

### 2. Description of Related Art

An injection molding machine fills a cavity space inside a mold device with a preheated molding material. A molded article can be obtained by solidifying the filled molding material. The molded article has the shape and dimensions equal to those of the cavity space. The temperature of the mold device is controlled by a temperature regulator.

### SUMMARY

According to an aspect of the present disclosure, a control device for an injection molding machine configured to fill a cavity space inside a mold device with a molding material includes a memory, a processor coupled to the memory, and a temperature regulator controller configured to control a temperature regulator configured to regulate a temperature of the mold device. The temperature regulator controller controls the temperature regulator based on a dew point temperature of a surface of the mold device, the surface forming the cavity space in the mold device.

### BRIEF DESCRIPTION OF THE DRAWINGS

FIG. 1 is a diagram illustrating a state of an injection molding machine according to an embodiment at the time of completion of mold opening;

FIG. 2 is a diagram illustrating a state of the injection molding machine according to the embodiment at the time of mold clamping;

FIG. 3 is a functional block diagram illustrating exemplary components of a control device;

FIG. 4 is a diagram illustrating an example of data used for estimating the dew point temperature;

FIG. 5 is a diagram illustrating another example of data used for estimating the dew point temperature;

FIG. 6 is a flowchart illustrating an example of a process performed by the control device;

FIG. 7 is a flowchart illustrating an example of a process performed in step S107; and

FIG. 8 is a flowchart illustrating an example of a process performed in step S109.

### DETAILED DESCRIPTION

An injection molding machine repeats filling a cavity space inside a mold device with a preheated molding material. In this process, the temperature of the surface of the mold device that forms the cavity space gradually rises. Hereinafter, the surface of the mold device that forms the cavity space may be simply referred to as a “cavity surface of the mold device”.

The temperature regulator controls the temperature of the mold device so that the temperature of the cavity surface of the mold device is stabilized at a temperature at which the molding material can be finally solidified. The temperature regulator controls the temperature of the cavity surface of the mold device by controlling the temperature of a temperature regulating medium supplied to the inside of the mold device, for example. The temperature regulating medium is, for example, water, but is not particularly limited thereto.

The temperature regulator may supply a temperature regulating medium having a temperature lower than a room temperature to the mold device before the mold device is sufficiently heated by the heat of the molding material, and the temperature of the cavity surface of the mold device may become equal to or lower than the dew point temperature. As a result, dew condensation may occur on the cavity surface.

If dew condensation occurs on the cavity surface of the mold device, a mold release failure occurs. When a mold release failure occurs, maintenance of the mold device or the like is required. Therefore, it takes time and labor to start mass production of molded articles. In addition, the molding material is wasted.

An embodiment of the present disclosure provides a technique for suppressing an occurrence of dew condensation on the cavity surface of the mold device and for inhibiting a mold release failures.

Hereinafter, embodiments of the present disclosure will be described with reference to the drawings. In the drawings, the same or corresponding components are denoted by the same or corresponding reference numerals, and the description thereof may be omitted.

### (Injection Molding Machine)

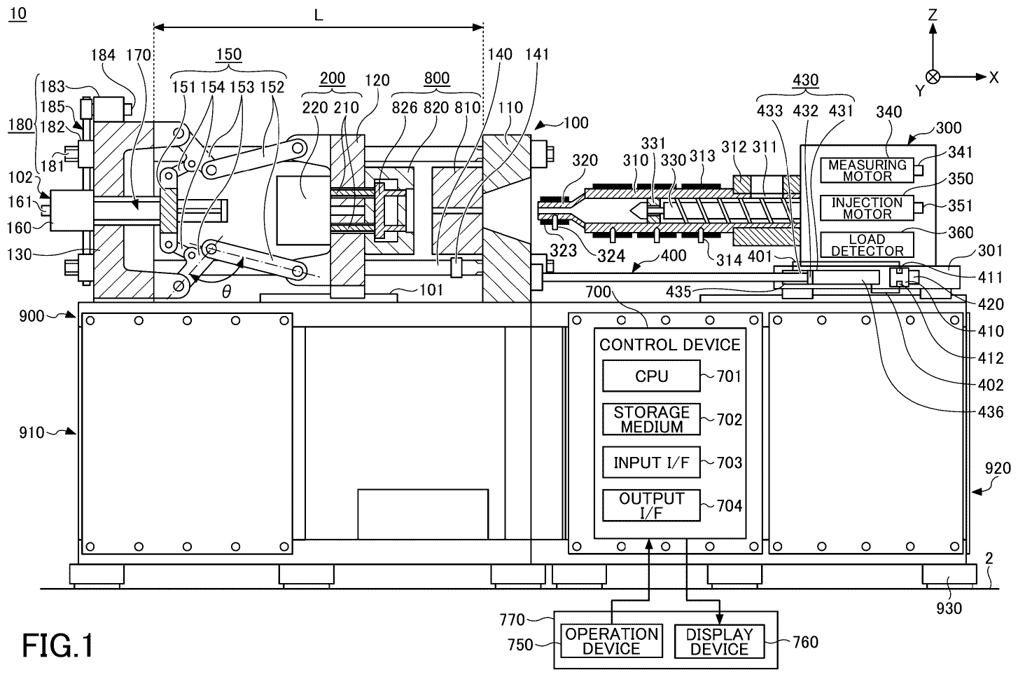

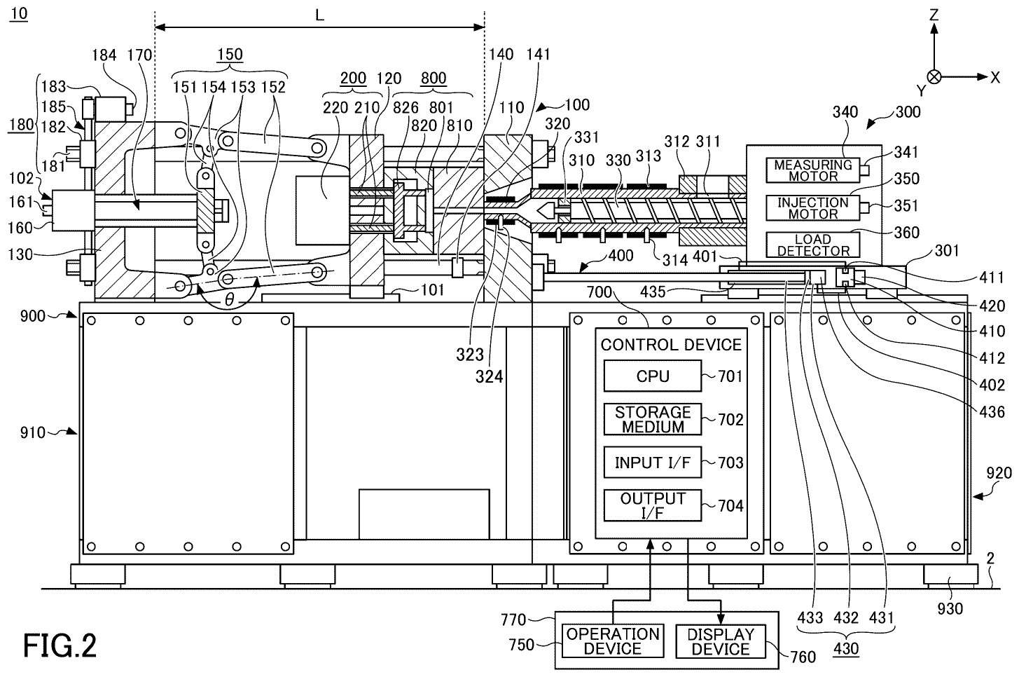

FIG. 1 is a diagram illustrating a state of an injection molding machine according to an embodiment at the time of completion of mold opening. FIG. 2 is a diagram illustrating a state of an injection molding machine according to the embodiment at the time of mold clamping. In the present specification, an X-axis direction, a Y-axis direction, and a Z-axis direction are directions perpendicular to each other. The X-axis direction and the Y-axis direction represent a horizontal direction, and the Z-axis direction represents a vertical direction. In the case where a mold clamping device 100 is a horizontal type, the X-axis direction is a mold opening/closing direction, and the Y-axis direction is a width direction of an injection molding machine 10. The negative side in the Y-axis direction is hereinafter called an “operation side”, and the positive side in the Y-axis direction is hereinafter called a “side opposite to the operation side”.

As illustrated in FIGS. 1 and 2, the injection molding machine 10 includes: a clamping device 100 that opens and closes the mold device 800; an ejector device 200 that ejects a molded article that is molded by the mold device 800; an injection device 300 that injects a molding material into the mold device 800; a moving device 400 that advances and retracts the injection device 300 with respect to the mold device 800; a control device 700 that controls each component of the injection molding machine 10; and a frame 900 that supports each component of the injection molding machine 10. The frame 900 includes a mold clamping device frame 910 that supports the mold clamping device 100 and an injection device frame 920 that supports the injection device 300. The mold clamping device frame 910 and the injection device frame 920 are installed on the floor 2 via leveling adjusters 930. The control device 700 is provided in the internal space of the injection device frame 920. Hereinafter, each component of the injection molding machine 10 will be described.

### (Mold Clamping Device)

In the description of the mold clamping device 100, a moving direction of a movable platen 120 at the time of mold closing (for example, an X-axis positive direction) is defined as the front, and a moving direction of the movable platen 120 at the time of mold opening (for example, an X-axis negative direction) is defined as the rear.

The mold clamping device 100 performs mold closing, pressure increasing, mold clamping, pressure releasing, and mold opening of the mold device 800. The mold device 800 includes a fixed mold 810 and a movable mold 820.

The mold clamping device 100 is, for example, a horizontal type, and the mold opening/closing direction is a horizontal direction. The mold clamping device 100 includes a fixed platen 110 to which the fixed mold 810 is attached, a movable platen 120 to which the movable mold 820 is attached, and a moving mechanism 102 that moves the movable platen 120 in the mold opening/closing direction with respect to the fixed platen 110.

The fixed platen 110 is fixed to the mold clamping device frame 910. A fixed mold 810 is attached to a surface of the fixed platen 110 facing the movable platen 120.

The movable platen 120 is disposed so as to be movable in the mold opening/closing direction with respect to the mold clamping device frame 910. A guide 101 for guiding the movable platen 120 is laid on the mold clamping device frame 910. The movable mold 820 is attached to a surface of the movable platen 120 facing the fixed platen 110.

The moving mechanism 102 moves the movable platen 120 frontward and rearward with respect to the fixed platen 110 to perform mold closing, pressure increasing, mold clamping, pressure releasing, and mold opening of the mold device 800. The moving mechanism 102 includes: a toggle support 130 disposed at a distance from the fixed platen 110; tie bars 140 each connecting the fixed platen 110 and the toggle support 130; a toggle mechanism 150 configured to move the movable platen 120 in the mold opening/closing direction with respect to the toggle support 130; a mold clamping motor 160 operating the toggle mechanism 150; a motion conversion mechanism 170 converting the rotational motion of the mold clamping motor 160 into linear motion; and a mold thickness adjustment mechanism 180 configured to adjust the distance between the fixed platen 110 and the toggle support 130.

The toggle support 130 is disposed apart from the fixed platen 110 and is placed on the mold clamping device frame 910 so as to be movable in the mold opening/closing direction. The toggle support 130 may be disposed so as to be movable along a guide laid on the mold clamping device frame 910. The guide of the toggle support 130 may be shared with the guide 101 of the movable platen 120.

In the present embodiment, although the fixed platen 110 is fixed to the mold clamping device frame 910, and the toggle support 130 is disposed so as to be movable in the mold opening/closing direction with respect to the mold clamping device frame 910, the toggle support 130 may be fixed to the mold clamping device frame 910, and the fixed platen 110 may be disposed so as to be movable in the mold opening/closing direction with respect to the mold clamping device frame 910.

The tie bar 140 connects the fixed platen 110 and the toggle support 130 with an interval L therebetween in the mold opening/closing direction. A plurality of (for example, four) tie bars 140 may be used. The plurality of tie bars 140 are arranged in parallel in the mold opening/closing direction and extend in accordance with a mold clamping force. At least one of the tie bars 140 is provided with a tie bar strain detector 141 for detecting strain of the tie bar 140. The tie bar strain detector 141 sends a signal indicating a result of the detection to the control device 700. The detection result of the tie bar strain detector 141 is used for detection of a mold clamping force and the like.

In the present embodiment, the tie bar strain detector 141 is used as a mold clamping force detector for detecting a mold clamping force, but the present disclosure is not limited thereto. The mold clamping force detector is not limited to a strain gauge type, and may be a piezoelectric type, a capacitance type, a hydraulic type, an electromagnetic type, or the like, and the attachment position thereof is not limited to the tie bar 140.

The toggle mechanism 150 is disposed between the movable platen 120 and the toggle support 130, and moves the movable platen 120 in the mold opening/closing direction with respect to the toggle support 130. The toggle mechanism 150 includes a crosshead 151 that moves in the mold opening/closing direction, and a pair of link groups that are bent and extended by the movement of the crosshead 151. The pair of link groups each include a first link 152 and a second link 153 which are connected to each other by a pin or the like so as to be bendable and extendable. The first link 152 is swingably attached to the movable platen 120 by a pin or the like. The second link 153 is swingably attached to the toggle support 130 by a pin or the like. The second link 153 is attached to the crosshead 151 via a third link 154. In response to the crosshead 151 moving frontward and rearward with respect to the toggle support 130, the first link 152 and the second link 153 are bent and extended, and the movable platen 120 is moved frontward and rearward with respect to the toggle support 130.

The configuration of the toggle mechanism 150 is not limited to the configuration illustrated in FIGS. 1 and 2. For example, in FIGS. 1 and 2, the number of nodes of each link group is five, but may be four, and one end of the third link 154 may be coupled to the node between the first link 152 and the second link 153.

The mold clamping motor 160 is attached to the toggle support 130 and operates the toggle mechanism 150. By moving the crosshead 151 frontward and rearward with respect to the toggle support 130, the mold clamping motor 160 bends and extends the first link 152 and the second link 153 and moves the movable platen 120 frontward and rearward with respect to the toggle support 130. The mold clamping motor 160 is directly connected to the motion conversion mechanism 170, but may be connected to the motion conversion mechanism 170 via a belt, a pulley, or the like.

The motion conversion mechanism 170 converts a rotational motion of the mold clamping motor 160 into the linear motion of the crosshead 151. The motion conversion mechanism 170 includes a screw shaft and a screw nut screwed to the screw shaft. Balls or rollers may be interposed between the screw shaft and the screw nut.

The mold clamping device 100 performs a mold closing step, a pressure increasing step, a mold clamping step, a pressure releasing step, a mold opening step, and the like under the control of the control device 700.

In the mold closing step, the mold clamping motor 160 is driven to advance the crosshead 151 to a mold closing completion position at a set moving speed, thereby advancing the movable platen 120 and causing the movable mold 820 to touch the fixed mold 810. The position and the moving speed of the crosshead 151 are detected by using, for example, a mold clamping motor encoder 161. The mold clamping motor encoder 161 detects the rotation of the mold clamping motor 160 and sends a signal indicating the detection result to the control device 700.

A crosshead position detector that detects the position of the crosshead 151 and a crosshead moving speed detector that detects the moving speed of the crosshead 151 are not limited to the mold clamping motor encoder 161, and general detectors can be used. The movable platen position detector for detecting the position of the movable platen 120 and the movable platen moving speed detector for detecting the moving speed of the movable platen 120 are not limited to the mold clamping motor encoder 161, and general detectors can be used.

In the pressure increasing step, a mold clamping force is generated by further driving the mold clamping motor 160 to further advance the crosshead 151 from the mold closing completion position to a mold clamping position.

In the mold clamping step, the mold clamping motor 160 is driven to maintain the position of the crosshead 151 at the mold clamping position. In the mold clamping step, the mold clamping force generated in the pressure increasing step is maintained. In the mold clamping step, a cavity space 801 (see FIG. 2) is formed between the movable mold 820 and the fixed mold 810, and the injection device 300 fills the cavity space 801 with a liquid molding material. The filled molding material is solidified to obtain a molded article.

There may be more than one cavity space 801. In this case, a plurality of molded articles are obtained simultaneously. An insert component may be disposed in one part of the cavity space 801, and a molding material may be filled in another part of the cavity space 801. A molded article in which the insert component and the molding material are integrated is obtained.

In the pressure releasing step, the movable platen 120 is retracted by driving the mold clamping motor 160 to retract the crosshead 151 from the mold clamping position to the mold opening start position, and the mold clamping force is thus reduced. The mold opening start position and the mold closing completion position may be the same position.

In the mold opening step, the movable platen 120 is retracted by driving the mold clamping motor 160 to retract the crosshead 151 from the mold opening start position to the mold opening completion position at a set moving speed, and the movable mold 820 is separated from the fixed mold 810. Thereafter, the ejector device 200 ejects the molded product from the movable mold 820.

The setting conditions for the mold closing step, the pressure increasing step, and the mold clamping step are collectively set as a series of setting conditions. For example, a moving speed and a position (including a mold closing start position, a moving speed switchover position, a mold closing completion position, and a mold clamping position) of the crosshead 151 for the mold closing step and the pressure increasing step, and the mold clamping force are collectively set as a series of setting conditions. A mold closing start position, a moving speed switchover position, a mold closing completion position, and a mold clamping position are arranged in this order from the rear to the front, and represent a start point and an end point of a section for which a moving speed is set. A moving speed is set for each section. The number of a moving speed switchover position may be one or more. A moving speed switchover position need not be set. Only either of a mold clamping position and a mold clamping force may be set.

The setting conditions for the pressure releasing step and the mold opening step are set in the same manner. For example, a moving speed and a position (a mold opening start position, a moving speed switchover position, a mold opening completion position) of the crosshead 151 for the pressure releasing step and the mold opening step are collectively set as a series of setting conditions. A mold opening start position, a moving speed switchover position, a mold opening completion position are arranged in this order from the front to the rear, and represent a start point and an end point of a section for which a moving speed is set. A moving speed is set for each section. The number of a moving speed switchover positions may be one or more. A moving speed switchover position need not be set. A mold opening start position and a mold closing completion position may be the same position. A mold opening completion position and a mold closing start position may be the same position.

Instead of a moving speed and a position of the crosshead 151, a moving speed and a position of the movable platen 120 may be set. Instead of a position of the crosshead (for example, a mold clamping position) or a position of the movable platen, a mold clamping force may be set.

The toggle mechanism 150 amplifies a driving force of the mold clamping motor 160 and transmits the amplified driving force to the movable platen 120. An amplification factor is also called a “toggle factor”. A toggle factor changes according to an angle θ formed by the first link 152 and the second link 153 (hereinafter, also referred to as a “link angle θ”). The link angle θ is obtained from the position of the crosshead 151. When the link angle θ is 180°, the toggle factor is maximized.

In the case where the thickness of the mold device 800 changes due to a replacement of the mold device 800 or a temperature change of the mold device 800, the mold thickness is adjusted so that a predetermined mold clamping force is obtained at the time of mold clamping. In the mold thickness adjustment, for example, an interval L between the fixed platen 110 and the toggle support 130 is adjusted so that the link angle θ of the toggle mechanism 150 becomes a predetermined angle at the time of the movable mold 820 touching the fixed mold 810 (or “mold touch”).

The mold clamping device 100 includes a mold thickness adjustment mechanism 180. The mold thickness adjustment mechanism 180 adjusts a mold thickness by adjusting an interval L between the fixed platen 110 and the toggle support 130. The mold thickness adjustment is performed at a timing between the end of a molding cycle and the start of a next molding cycle, for example. The mold thickness adjustment mechanism 180 includes, for example, a screw shaft 181 formed at the rear end portion of the tie bar 140, a screw nut 182 held by the toggle support 130 so as to be rotatable and not to be movable frontward and rearward, and a mold thickness adjustment motor 183 that rotates the screw nut 182 screwed to the screw shaft 181.

The screw shaft 181 and the screw nut 182 are provided for each tie bar 140. A rotational driving force of the mold thickness adjustment motor 183 may be transmitted to the plurality of screw nuts 182 via the rotational driving force transmitter 185. The plurality of screw nuts 182 can be rotated synchronously. The plurality of screw nuts 182 can be individually rotated by changing the transmission path of the rotational driving force transmitter 185.

The rotational driving force transmitter 185 is configured by, for example, a gear. In this case, a driven gear is formed on the outer periphery of each screw nut 182, a driving gear is attached to the output shaft of the mold thickness adjustment motor 183, and an intermediate gear which meshes with the plurality of driven gears and the driving gear is rotatably held at the center of the toggle support 130. The rotational driving force transmitter 185 may be configured by a belt, a pulley, or the like instead of the gear.

The operation of the mold thickness adjustment mechanism 180 is controlled by the control device 700. The control device 700 drives the mold thickness adjustment motor 183 to rotate the screw nuts 182. As a result, the position of the toggle support 130 with respect to the tie bar 140 is adjusted, and the interval L between the fixed platen 110 and the toggle support 130 is adjusted. A plurality of mold thickness adjustment mechanisms may be used in combination.

The interval L is detected by using the mold thickness adjustment motor encoder 184. The mold thickness adjustment motor encoder 184 detects a rotation amount and a rotation direction of the mold thickness adjustment motor 183 and sends a signal indicating the detection result to the control device 700. The detection result of the mold thickness adjustment motor encoder 184 is used for monitoring and controlling the position of the toggle support 130 and the interval L. The toggle support position detector for detecting the position of the toggle support 130 and the interval detector for detecting the interval L are not limited to the mold thickness adjustment motor encoder 184, and general detectors can be used.

The mold clamping device 100 may include a mold temperature regulator that controls the temperature of the mold device 800. The mold device 800 has a flow path for a temperature regulating medium therein. The mold temperature regulator controls the temperature of the mold device 800 by controlling the temperature of a temperature regulating medium supplied to the flow path of the mold device 800.

The mold clamping device 100 of the present embodiment is a horizontal type in which the mold opening/closing direction is a horizontal direction, but may be a vertical type in which the mold opening/closing direction is a vertical direction.

The mold clamping device 100 of the present embodiment includes the mold clamping motor 160 as a drive but may include a hydraulic cylinder instead of the mold clamping motor 160. The mold clamping device 100 may include a linear motor for mold opening and closing and an electromagnet for mold clamping.

### (Ejector Device)

In the description of the ejector device 200, similarly to the descriptions of the mold clamping device 100, a moving direction of the movable platen 120 at the time of mold closing (for example, an X-axis positive direction) is defined as the front, and a moving direction of the movable platen 120 at the time of mold opening (for example, an X-axis negative direction) is defined as the rear.

The ejector device 200 is attached to the movable platen 120 and moves frontward and rearward together with the movable platen 120. The ejector device 200 includes an ejector rod 210 that ejects a molded article from the mold device 800, and a drive mechanism 220 that moves the ejector rod 210 in the moving direction (X-axis direction) of the movable platen 120.

The ejector rod 210 is disposed in a through-hole of the movable platen 120 so as to be movable frontward and rearward. The front end portion of the ejector rod 210 is in contact with the ejector plate 826 of the movable mold 820. The front end of the ejector rod 210 may be connected to the ejector plate 826 or need not be connected to the ejector plate 826.

The drive mechanism 220 includes, for example, an ejector motor and a motion conversion mechanism that converts a rotational motion of the ejector motor into a linear motion of the ejector rod 210. The motion conversion mechanism includes a screw shaft and a screw nut screwed to the screw shaft. Balls or rollers may be interposed between the screw shaft and the screw nut.

The ejector device 200 performs the ejection process under the control of the control device 700. In the ejection step, the ejector rod 210 is advanced from the standby position to the ejection position at a set moving speed, whereby the ejector plate 826 is advanced and the molded article is ejected. Thereafter, the ejector motor is driven to retract the ejector rod 210 at a set moving speed, and the ejector plate 826 is retracted to the original standby position.

The position and the moving speed of the ejector rod 210 are detected by using, for example, an ejector motor encoder. The ejector motor encoder detects a rotation of the ejector motor and sends a signal indicating the detection result to the control device 700. The ejector rod position detector for detecting the position of the ejector rod 210 and the ejector rod moving speed detector for detecting the moving speed of the ejector rod 210 are not limited to the ejector motor encoder, and general detectors can be used.

### (Injection Device)

In the descriptions of the injection device 300, unlike the descriptions of the mold clamping device 100 and the descriptions of the ejector device 200, a moving direction of the screw 330 at the time of filling (for example, the X-axis negative direction) is defined as the front, and a moving direction of the screw 330 at the time of metering (for example, the X-axis positive direction) is defined as the rear.

The injection device 300 is installed on a slide base 301, and the slide base 301 is disposed so as to be movable frontward and rearward with respect to an injection device frame 920. The injection device 300 is disposed so as to be movable frontward and rearward with respect to the mold device 800. The injection device 300 touches the mold device 800 and fills the cavity space 801 in the mold device 800 with a molding material. The injection device 300 includes, for example, a cylinder 310 that heats a molding material, a nozzle 320 provided at a front end portion of the cylinder 310, a screw 330 disposed in the cylinder 310 so as to be movable frontward and rearward and rotatable, a metering motor 340 that rotates the screw 330, an injection motor 350 that moves the screw 330 frontward and rearward, and a load detector 360 that detects a load transmitted between the injection motor 350 and the screw 330.

The cylinder 310 heats the molding material supplied from a supply port 311 to the inside. The molding material includes, for example, a resin. The molding material is formed in a pellet shape, for example, and is supplied to the supply port 311 in a solid state. The supply port 311 is formed in a rear portion of the cylinder 310. A cooler 312, such as a water-cooled cylinder or the like, is provided on the outer periphery of the rear portion of the cylinder 310. A first heater 313, such as a band heater or the like, and a first temperature detector 314 are provided on the outer periphery of the cylinder 310 in front of the cooler 312.

The cylinder 310 is divided into a plurality of zones in the axial direction (for example, the X-axis direction) of the cylinder 310. The first heater 313 and the first temperature detector 314 are provided in each of the plurality of zones. A set temperature is set for each of the zones, and the control device 700 controls the first heater 313 so that the temperature detected by the first temperature detector 314 reaches the set temperature.

The nozzle 320 is provided at the front end portion of the cylinder 310 and is pressed against the mold device 800. A second heater 323 and a second temperature detector 324 are provided on the outer periphery of the nozzle 320. The control device 700 controls the second heater 323 so that the temperature detected by the nozzle 320 reaches the set temperature.

The screw 330 is disposed in the cylinder 310 so as to be rotatable and movable frontward and rearward. As the screw 330 is rotated, a molding material is pushed frontward along the spiral groove of the screw 330. The molding material is gradually melted by the heat from the cylinder 310 while being pushed frontward. As the liquid molding material is pushed to the front of the screw 330 and accumulated in the front portion of the cylinder 310, the screw 330 is retracted. Thereafter, as the screw 330 is advanced, the liquid molding material accumulated in front of the screw 330 is injected from the nozzle 320 and is filled into the mold device 800.

A backflow prevention ring 331 is attached to the front portion of the screw 330 so as to be movable frontward and rearward as a backflow prevention valve that prevents backflow of a molding material from the front to the rear of the screw 330 at the time of pushing the screw 330 frontward.

When the screw 330 is advanced, the backflow prevention ring 331 is pushed rearward by the pressure of the molding material in front of the screw 330, and is retracted relative to the screw 330 to a closure position (see FIG. 2) at which the backflow prevention ring 331 closes the flow path of the molding material. This prevents the molding material accumulated in front of the screw 330 from flowing rearward.

On the other hand, when the screw 330 is rotated, the backflow prevention ring 331 is pushed frontward by the pressure of the molding material pushed frontward along the spiral groove of the screw 330, and is advanced relative to the screw 330 to a release position (see FIG. 1) at which the backflow prevention ring 331 opens the flow path of the molding material. Thus, the molding material is pushed to the front of the screw 330.

The backflow prevention ring 331 may be either a co-rotation type that rotates together with the screw 330 or a non-co-rotation type that does not rotate together with the screw 330.

The injection device 300 may include a drive source that moves the backflow prevention ring 331 frontward and rearward between the release position and the closure position with respect to the screw 330.

The metering motor 340 rotates the screw 330. The drive source for rotating the screw 330 is not limited to the metering motor 340, and may be, for example, a hydraulic pump.

The injection motor 350 moves the screw 330 frontward and rearward. A motion conversion mechanism or the like for converting a rotational motion of the injection motor 350 into a linear motion of the screw 330 is provided between the injection motor 350 and the screw 330. The motion conversion mechanism includes, for example, a screw shaft and a screw nut screwed to the screw shaft. Balls, rollers, or the like may be provided between the screw shaft and the screw nut. The drive source for advancing and retracting the screw 330 is not limited to the injection motor 350, and may be, for example, a hydraulic cylinder.

The load detector 360 detects a load transmitted between the injection motor 350 and the screw 330. The detected load is converted into a pressure by the control device 700. The load detector 360 is provided in a load transmission path between the injection motor 350 and the screw 330, and detects a load acting on the load detector 360.

The load detector 360 sends a signal of the detected load to the control device 700. The load detected by the load detector 360 is converted into a pressure acting between the screw 330 and a molding material, and is used for controlling or monitoring a pressure received by the screw 330 from a molding material, a back pressure to the screw 330, a pressure acting on a molding material from the screw 330, and the like.

A pressure detector for detecting the pressure of a molding material is not limited to the load detector 360, and a general pressure detector can be used. For example, a nozzle pressure sensor or a mold internal pressure sensor may be used. The nozzle pressure sensor is installed at the nozzle 320. The mold internal pressure sensor is installed inside the mold device 800.

The injection device 300 performs a metering step, a filling step, a dwelling step, and the like under the control of the control device 700. The filling step and the dwelling step may be collectively referred to as an “injection step”.

In the metering step, the metering motor 340 is driven to rotate the screw 330 at a set rotation speed, and the molding material is pushed frontward along the spiral groove of the screw 330. As a result, the molding material is gradually melted. As the liquid molding material is pushed to the front of the screw 330 and accumulated in the front portion of the cylinder 310, the screw 330 is retracted. The rotation speed of the screw 330 is detected by using, for example, the metering motor encoder 341. The metering motor encoder 341 detects the rotation of the metering motor 340 and sends a signal indicating the detection result to the control device 700. A screw rotational speed detector for detecting the rotational speed of the screw 330 is not limited to the metering motor encoder 341, and a general detector can be used.

In the metering step, in order to suppress a rapid retreat of the screw 330, the injection motor 350 may be driven to apply a set back pressure to the screw 330. The back pressure to the screw 330 is detected by using, for example, the load detector 360. When the screw 330 is retracted to a metering completion position and a predetermined amount of the molding material is accumulated in front of the screw 330, the metering step is completed.

A position and a rotation speed of the screw 330 for the metering step are collectively set as a series of setting conditions. For example, a metering start position, a rotational speed switchover position, and a metering completion position are set. These positions are arranged in this order from the front to the rear, and represent the start point and the end point of a section for which a rotation speed is set. A rotation speed is set for each section. The number of a rotation speed switchover position may be one or more. A rotation speed switchover position need not be set. A back pressure is set for each section.

In the filling step, the injection motor 350 is driven to move the screw 330 frontward at a set moving speed, and a liquid molding material accumulated in front of the screw 330 is filled in the cavity space 801 in the mold device 800. The position and the moving speed of the screw 330 are detected by using, for example, the injection motor encoder 351. The injection motor encoder 351 detects the rotation of the injection motor 350 and sends a signal indicating the detection result to the control device 700. When the position of the screw 330 reaches a set position, changeover from the filling step to the dwelling step (so-called V/P switchover) is performed. The position where the V/P switchover is performed is also referred to as a “V/P switchover position”. A set moving speed of the screw 330 may be changed according to the position of the screw 330, time, or the like.

A position and a moving speed of the screw 330 for the filling step are collectively set as a series of setting conditions. For example, a filling start position (also referred to as an “injection start position”), a moving speed switchover position, and a V/P switchover position are set. These positions are arranged in this order from the rear to the front, and represent the start point and the end point of a section for which a rotation speed is set. A moving speed is set for each section. The number of a moving speed switchover position may be one or more. A moving speed switchover position need not be set.

An upper limit value of the pressure of the screw 330 is set for each section for which a moving speed of the screw 330 is set. The pressure of the screw 330 is detected by the load detector 360. In the case where the pressure of the screw 330 is equal to or lower than the set pressure, the screw 330 is moved frontward at the set moving speed. On the other hand, in the case where the pressure of the screw 330 exceeds the set pressure, for the purpose of protecting the mold, the screw 330 is advanced at a moving speed lower than the set moving speed so that the pressure of the screw 330 becomes equal to or lower than the set pressure.

Note that, after the position of the screw 330 reaches the V/P switchover position in the filling step, the screw 330 may be temporarily stopped at the V/P switchover position, and then V/P switchover may be performed. Immediately before V/P switchover, the screw 330 may be advanced or retracted at a very low speed instead of stopping the screw 330. A screw position detector for detecting the position of the screw 330 and a screw moving speed detector for detecting the moving speed of the screw 330 are not limited to the injection motor encoder 351, and general detectors can be used.

In the dwelling step, the injection motor 350 is driven to push the screw 330 frontward, and the pressure of a molding material at the front end portion of the screw 330 (hereinafter, also referred to as a “dwelling pressure”) is remained at the set pressure, and the molding material remaining in the cylinder 310 is pushed toward the mold device 800. The molding material can be thus replenished by the shortage due to cooling shrinkage in the mold device 800. The dwelling pressure is detected by using, for example, the load detector 360. The set value of the dwelling pressure may be changed according to a length of time elapsed from the start of the dwelling step. A plurality of dwelling pressures and durations during which a dwelling pressure is maintained in the dwelling step may be set, and may be collectively set as a series of setting conditions.

In the dwelling step, a molding material in the cavity space 801 in the mold device 800 is gradually cooled, and when the dwelling step is completed, the inlet of the cavity space 801 is closed by the solidified molding material. This state is called a “gate seal”, and a backflow of the molding material from the cavity space 801 is prevented. After the dwelling step, the cooling step is started. In the cooling step, the molding material in the cavity space 801 is solidified. In order to shorten a molding cycle time, a metering step may be performed during the cooling step.

The injection device 300 of the present embodiment is of an in-line screw type but may be of a pre-plasticization type. A pre-plasticizing injection device supplies a molding material melted in a plasticizing cylinder to an injection cylinder, and injects the molding material from the injection cylinder into a mold device. In the plasticizing cylinder, a screw is disposed rotatably and unmovably frontward and rearward, or a screw is disposed rotatably and movably frontward and rearward. On the other hand, a plunger is disposed in the injection cylinder so as to be movable frontward and rearward.

The injection device 300 of the present embodiment is a horizontal type in which the axial direction of the cylinder 310 is the horizontal direction, but may be a vertical type in which the axial direction of the cylinder 310 is the vertical direction. The mold clamping device combined with the vertical injection device 300 may be a vertical type or a horizontal type. Similarly, the mold clamping device combined with the vertical injection device 300 may be a vertical type or a horizontal type.

### (Moving Device)

In the descriptions of the moving device 400, similarly to the descriptions of the injection device 300, a moving direction of the screw 330 at the time of filling (for example, the X-axis negative direction) is defined as the front, and a moving direction of the screw 330 at the time of metering (for example, the X-axis positive direction) is defined as the rear.

The moving device 400 advances and retracts the injection device 300 with respect to the mold device 800. The moving device 400 presses the nozzle 320 against the mold device 800 to generate a nozzle touch pressure. The moving device 400 includes a hydraulic pump 410, a motor 420 as a drive source, a hydraulic cylinder 430 as a hydraulic actuator, and the like.

The hydraulic pump 410 has a first port 411 and a second port 412. The hydraulic pump 410 is a pump capable of rotating in both directions, and generates a hydraulic pressure by switching/the rotation direction of the motor 420 to suck a working liquid (for example, oil) from either of the first port 411 and the second port 412 and discharge the liquid from the other. The hydraulic pump 410 can also suck a working liquid from the tank and discharge the working liquid from either of the first port 411 and the second port 412.

The motor 420 operates the hydraulic pump 410. The motor 420 drives the hydraulic pump 410 in a rotational direction and with a rotational torque corresponding to a control signal from the control device 700. The motor 420 may be an electric motor or an electric servo motor.

The hydraulic cylinder 430 includes a cylinder main body 431, a piston 432, and a piston rod 433. The cylinder main body 431 is fixed to the injection device 300. The piston 432 divides the interior of the cylinder main body 431 into a front chamber 435 as a first chamber and a rear chamber 436 as a second chamber. The piston rod 433 is fixed relative to the fixed platen 110.

The front chamber 435 of the hydraulic cylinder 430 is connected to the first port 411 of the hydraulic pump 410 via a first flow path 401. The working liquid discharged from the first port 411 is supplied to the front chamber 435 via the first flow path 401, and thus the injection device 300 is pushed frontward. The injection device 300 is advanced, and the nozzle 320 is pressed against the fixed mold 810. The front chamber 435 functions as a pressure chamber that generates a nozzle touch pressure of the nozzle 320 by the pressure of the working liquid supplied from the hydraulic pump 410.

The rear chamber 436 of the hydraulic cylinder 430 is connected to the second port 412 of the hydraulic pump 410 via a second flow path 402. The working liquid discharged from the second port 412 is supplied to the rear chamber 436 of the hydraulic cylinder 430 via the second flow path 402, and thus the injection device 300 is pushed rearward. The injection device 300 is retracted, and the nozzle 320 is separated from the fixed mold 810.

In the present embodiment, the moving device 400 includes the hydraulic cylinder 430, but the present disclosure is not limited to this example. For example, instead of the hydraulic cylinder 430, an electric motor and a motion conversion mechanism that converts the rotational motion of the electric motor into the linear motion of the injection device 300 may be used.

### (Control Device)

The control device 700 is configured by, for example, a computer, and includes a central processing unit (CPU) 701, a storage medium 702 such as a memory, an input interface 703, and an output interface 704 as illustrated in FIGS. 1 and 2. The control device 700 performs various controls by causing the CPU 701 to execute programs stored in the storage medium 702. The control device 700 receives a signal from an external device through the input interface 703 and transmits a signal to an external device through the output interface 704.

The control device 700 repeatedly performs the metering step, the mold closing step, the pressure increasing step, the mold clamping step, the filling step, the dwelling step, the cooling step, the pressure releasing step, the mold opening step, the ejection step, and the like, thereby repeatedly manufacturing a molded product. A series of operations for obtaining a molded article, for example, an operation from the start of the metering step to the start of the next metering step is also referred to as a “shot” or a “molding cycle”. A time required for one shot is referred to as a “molding cycle time” or a “cycle time”.

One molding cycle includes, for example, a metering step, a mold closing step, a pressure increasing step, a mold clamping step, a filling step, a dwelling step, a cooling step, a pressure releasing step, a mold opening step, and an ejection step in this order. The order here is the order of the start of each step. The filling step, the dwelling step, and the cooling step are performed during the mold clamping step. The start of the mold clamping step may coincide with the start of the filling step. The completion of the pressure releasing step coincides with the start of the mold opening step.

In order to shorten a molding cycle time, a plurality of steps may be performed at the same time. For example, the metering step may be performed during the cooling step of the previous molding cycle, or may be performed during the mold clamping step. In this case, the mold closing step may be performed at the beginning of the molding cycle. The filling step may be started during the mold closing step. The ejection step may be started during the mold opening step. In the case where an opening/closing valve that opens and closes the flow path of the nozzle 320 is provided, the mold opening process may be started during the metering process. This is because even if the mold opening step is started during the metering step, a molding material does not leak from the nozzle 320 as long as the opening/closing valve closes the flow path of the nozzle 320.

One molding cycle may include a step other than the metering step, the mold closing step, the pressure increasing step, the mold clamping step, the filling step, the dwelling step, the cooling step, the pressure releasing step, the mold opening step, and the ejection step.

For example, after the completion of the dwelling step, before the start of the metering step, a pre-metering suck back process of retracting the screw 330 to a predetermined metering start position may be performed. This reduces the pressure of a molding material accumulated in front of the screw 330 before the start of the metering step, and a rapid retreat of the screw 330 at the start of the metering process can be thereby prevented.

After the completion of the metering step yet before the start of the filling step, a post-metering suck back step may be performed after the metering to retract the screw 330 to a preset filling start position (also referred to as an “injection start position”). This reduces the pressure of a molding material accumulated in front of the screw 330 before the start of the filling step, and a leakage of the molding material from the nozzle 320 before the start of the filling step can be thereby prevented.

The control device 700 is connected to an operation device 750 that receives an input operation by a user and a display device 760 on which a screen is displayed. The operation device 750 and the display device 760 may be configured by, for example, a touch panel 770 and may be integrated. The touch panel 770 as the display device 760 is caused to display a screen under the control of the control device 700. For example, information, such as setting of the injection molding machine 10 and a current state of the injection molding machine 10, may be displayed on the screen of the touch panel 770. On the screen of the touch panel 770, an operation unit, such as a button or an input field for receiving an input operation by a user, may be displayed, for example. The touch panel 770 as the operation device 750 detects an input operation on the screen by a user and outputs a signal corresponding to the input operation to the control device 700. Thus, for example, a user can perform setting (including input of a setting value) of the injection molding machine 10 by operating the operation unit provided on the screen while checking information displayed on the screen. A user's operation of the operation unit provided on the screen can cause the injection molding machine 10 to perform an operation corresponding to the operation. The operation of the injection molding machine 10 may be, for example, an operation (including stopping) of the mold clamping device 100, the ejector device 200, the injection device 300, the moving device 400, or the like. The operation of the injection molding machine 10 may be switching of a screen displayed on the touch panel 770 as the display device 760.

Note that the operation device 750 and the display device 760 of the present embodiment are described as being integrated as the touch panel 770, but may be provided separately. A plurality of operation devices 750 may be provided. The operation device 750 and the display device 760 are disposed on the operation side (Y-axis negative direction) of the mold clamping device 100 (more specifically, the fixed platen 110).

### (Details of Control Device)

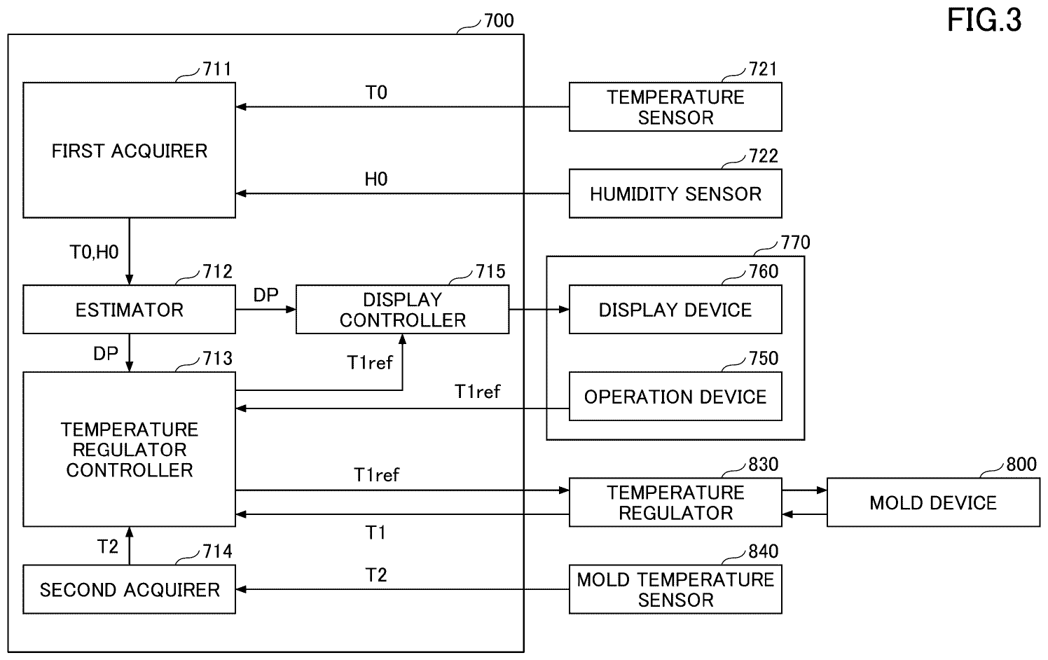

Next, an example of the components of the control device 700 will be described with reference to FIG. 3. Note that the functional blocks illustrated in FIG. 3 are conceptual and do not necessarily have to be physically configured as illustrated in FIG. 3. All or some of the functional blocks may be configured to be functionally or physically distributed or integrated in freely-determined units. All or any part of the processing functions performed by the functional blocks may be implemented by a program executed by the CPU or may be implemented as hardware by wired logic.

As illustrated in FIG. 3, the control device 700 includes, for example, a first acquirer 711, an estimator 712, a temperature regulator controller 713, a second acquirer 714, and a display controller 715. The first acquirer 711 acquires a temperature TO and a humidity H0 of the surrounding atmosphere of the injection molding machine 10. The estimator 712 estimates a dew point temperature DP of the cavity surface of the mold device 800 based on the temperature TO and the humidity H0 acquired by the first acquirer 711. The cavity surface is a surface that forms the cavity space 801 (see FIGS. 1 and 2). The temperature regulator controller 713 controls the temperature regulator 830 based on the dew point temperature DP of the cavity surface of the mold device 800. The second acquirer 714 acquires a temperature T2 of the cavity surface of the mold device 800. The display controller 715 controls the display device 760. Each of the components will be described below.

The first acquirer 711 acquires, as described above, a temperature TO and a humidity H0 of the surrounding atmosphere of the injection molding machine 10. A temperature TO is, for example, a temperature inside a factory in which the injection molding machine 10 is installed, and is acquired by a temperature sensor 721. A humidity H0 is, for example, a temperature inside the factory in which the injection molding machine 10 is installed, and is acquired by a humidity sensor 722. The humidity H0 may be a relative humidity or an absolute humidity. A relative humidity is a ratio of a partial pressure of water vapor to a saturated vapor pressure of water (partial pressure of water vapor/saturated vapor pressure of water). An absolute humidity is a weight of an amount of water vapor contained in 1 kg of dry air.

The temperature sensor 721 detects a temperature TO and transmits an electric signal indicating the detection result to the first acquirer 711. The humidity sensor 722 detects a humidity H0 and transmits an electric signal indicating the detection result to the first acquirer 711. The temperature sensor 721 and the humidity sensor 722 are attached to, for example, a mold clamping cover that covers the mold clamping device 100. The installation locations of the temperature sensor 721 and the humidity sensor 722 are not particularly limited. The temperature sensor 721 and the humidity sensor 722 may be provided as a part of the injection molding machine 10 or may be provided separately from the injection molding machine 10. A sensor that serves as both the temperature sensor 721 and the humidity sensor 722 may be used.

The estimator 712 estimates, as described above, a dew point temperature DP of the cavity surface of the mold device 800 based on a temperature TO and a humidity H0 acquired by the first acquirer 711. A dew point temperature DP is a temperature at which dew condensation occurs when air is cooled, and is a temperature at which air is in equilibrium with water and is saturated. A dew-point temperature DP varies depending on the weather. Alternatively, a dew-point temperature DP varies depending on the air conditioning in the factory in which the injection molding machine 10 is installed.

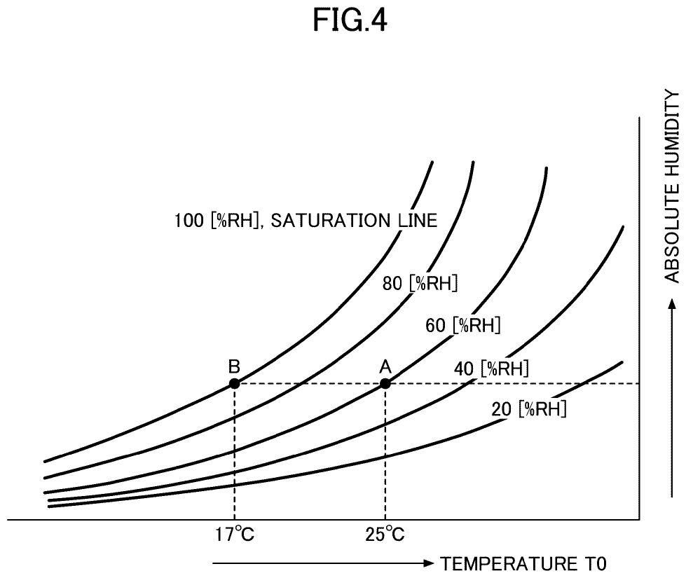

The estimator 712 has a database indicating the relationship between a temperatures T0, a humidity H0, and a dew-point temperatures DP, and estimates a dew-point temperature DP based on the database. For example, the estimator 712 has a psychrometric chart as illustrated in FIG. 4. In FIG. 4, point A is a state point when T0 is 25° C. and H0 is 60% RH. Point B is a point obtained by moving point A in a direction in which a temperature T0 of the air is cooled (leftward in FIG. 4) until point A intersects the saturation line. The temperature of point B (e.g., 17° C.) is a dew point temperature DP.

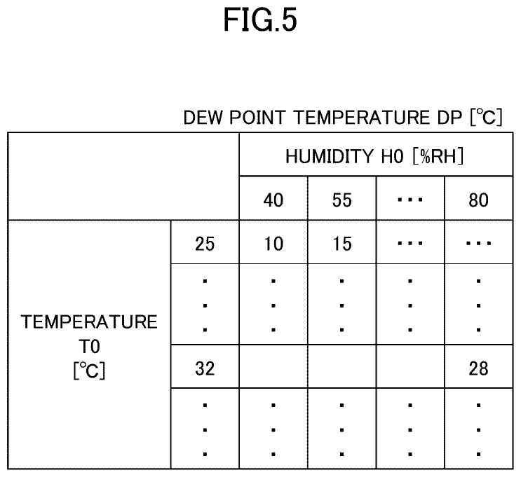

The estimator 712 may include a database in a table format as illustrated in FIG. 5. In the case where the estimator 712 includes a database in a table format, the estimator 712 may estimate a dew point temperature DP by interpolation or extrapolation. The format of the database is not particularly limited.

The temperature regulator controller 713 controls, as described above, the temperature regulator 830 based on a dew point temperature DP of the cavity surface of the mold device 800. For example, the temperature regulator controller 713 controls a set temperature T1ref of the temperature regulator 830. The temperature regulator 830 has a temperature sensor for measuring a temperature T1 of the temperature regulator 830, and performs feedback control of a temperature T1 so that a measured temperature T1 becomes equal to a set temperature T1ref. The temperature regulator 830 controls a temperature T1 of the cavity surface of the mold device 800 by controlling a temperature T2 of a temperature regulating medium supplied to the inside of the mold device 800, for example. The temperature regulating medium is, for example, water, but is not particularly limited thereto. The temperature regulator 830 includes a temperature sensor for measuring a temperature T1 of the temperature regulating medium, and transmits an electric signal indicating the measurement result of the temperature sensor to the temperature regulator controller 713.

The temperature regulator 830 may control a temperature T1 of the temperature regulating medium discharged from the inside of the mold device 800 to the outside and then return the temperature regulating medium to the inside of the mold device 800. The temperature sensor of the temperature regulator 830 may detect the temperature of the temperature regulating medium after the temperature control or may detect the temperature of the temperature regulating medium before the temperature control.

The injection molding machine 10 repeats filling the cavity space 801 inside the mold device 800 with a preheated molding material. In this process, a temperature T2 of the cavity surface of the mold device 800 gradually rises. A set temperature T1ref is set so that a temperature T2 of the cavity surface is stabilized at a temperature at which the molding material can be finally solidified. The set temperature T1ref (specifically, a second set temperature T1ref_final, which is described later) is input to the operation device 750, for example.

The set temperature T1ref (specifically, a second set temperature T1ref_final, which is described later) may be set to a temperature lower than a room temperature (specifically, a temperature T0 acquired by the first acquirer 711). If the temperature regulator 830 supplies the temperature regulating medium having a temperature T1 lower than a room temperature to the mold device 800 before the mold device 800 is sufficiently heated by the heat of the molding material, a temperature T2 of the cavity surface of the mold device 800 may become equal to or lower than a dew point temperature DP. DP is usually smaller than T0.

The temperature regulator controller 713 controls, as described above, the temperature regulator 830 based on a dew point temperature DP of the cavity surface of the mold device 800. For this reason, a temperature T2 of the cavity surface of the mold device 800 can be maintained higher than a dew point temperature DP. It is thus possible to suppress the occurrence of dew condensation on the cavity surface of the mold device 800, and to inhibit mold release failures. As a result, the frequency of maintenance of the mold device 800 can be reduced. Therefore, the time and labor required for starting mass production of molded articles can be reduced. Furthermore, the amount of molding material used can be reduced.

The temperature regulator controller 713 preferably performs control to lower a set temperature T1ref of the temperature regulator 830 from a first set temperature T1ref_start to a second set temperature T1ref_final in the process of the injection molding machine 10 repeatedly manufacturing molded articles. A first set temperature T1ref_start is higher than A second set temperature T1ref_final (T1ref_start>T1ref_final) and higher than a dew point temperature DP (T1ref_start>DP). A second set temperature T1ref_final is lower than a temperature TO of the surrounding atmosphere of the injection molding machine 10 (T1ref_final<T0), and may be equal to or lower than the dew-point temperature DP (T1ref_final≤DP). DP is usually smaller than TO.

According to the present embodiment, in the process in which the injection molding machine 10 repeatedly manufactures molded articles and a temperature T2 of the cavity surface of the mold device 800 gradually rises, the temperature regulator controller 713 performs control to lower the set temperature T1ref of the temperature regulator 830 from a first set temperature T1ref_start to a second set temperature T1ref_final. This can prevent a temperature T2 of the cavity surface of the mold device 800 from becoming equal to or lower than a dew point temperature DP before the mold device 800 is sufficiently heated by the heat of a molding material. When the temperature of the cavity surface becomes stable, the temperature T2 of the cavity surface finally reaches a temperature at which the molding material can be solidified.

A concrete example of the control of the temperature regulator controller 713 to lower a set temperature T1ref of the temperature regulator 830 from a first set temperature T1ref_start to a second set temperature T1ref_final will be described later.

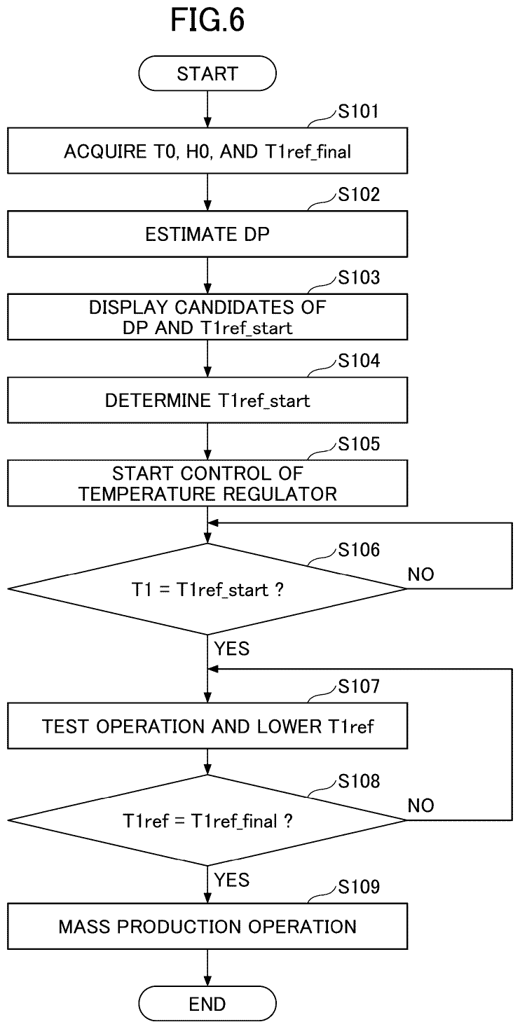

Next, an example of the process performed by the control device 700 will be described with reference to FIG. 6. The process illustrated in FIG. 6 is performed at the time of start-up of the injection molding machine 10. First, the first acquirer 711 acquires a temperature T and a humidity H of a surrounding atmosphere of the injection molding machine 10, and the temperature regulator controller 713 acquires a second set temperature T1ref_final (step S101). The second set temperature T1ref_final is input, for example, at the operation device 750.

Next, the estimator 712 estimates a dew point temperature DP of the cavity surface of the mold device 800 based on the temperature TO and the humidity H0 acquired by the first acquirer 711 (step S102). Thereafter, the temperature regulator controller 713 calculates a candidate for a first set temperature T1ref_start based on the dew-point temperature DP. For example, the candidate of the first set temperature T1ref_start may be higher than the dew point temperature DP by a preset amount (for example, 10° C.).

Next, the display controller 715 performs control to cause the display device 760 to display candidates of the dew-point temperature DP and the first set temperature T1ref_start (step S103). The display controller 715 may further perform control to cause the display device 760 to display at least one selected from the temperature T0 and the humidity H0 of the surrounding atmosphere of the injection molding machine 10, the temperature T1 of the temperature regulator 830, and the temperature T2 of the cavity surface of the mold device 800.

Next, the temperature regulator controller 713 determines the first set temperature T1ref_start (step S104). The first set temperature T1ref_start may be (A) a temperature calculated in advance by the temperature regulator controller 713 (for example, a temperature higher than the dew point temperature DP by a preset amount) or (B) a temperature input to the operation device 750 by the user of the injection molding machine 10 while viewing the display (for example, the dew point temperature DP) of the display device 760. A user of the injection molding machine 10 can select in advance whether to automatically determine the first set temperature T1ref_start or to manually determine it using the operation device 750.

Next, the temperature regulator controller 713 starts control of the temperature regulator 830 (step S105). The temperature regulator 830 performs feedback control on the temperature T1 of the temperature regulator 830 so that the temperature T1 of the temperature regulating medium becomes equal to the first set temperature T1ref_start, for example. After step S105, the temperature regulator controller 713 checks whether the temperature T1 of the temperature regulator 830 has become equal to the first set temperature T1ref_start (step S106). The step S106 is repeatedly performed until the temperature T1 of the temperature regulator 830 becomes equal to the first set temperature T1ref_start. It suffices that the temperature T1 of the temperature regulator 830 becomes equal to the first set temperature T1ref_start within a tolerance.

In the case where the temperature T1 of the temperature regulator 830 is equal to the first set temperature T1ref_start (YES in step S106), this means that the temperature of the cavity surface of the mold device 800 has reached a desired temperature, and the molding material can be solidified inside the mold device 800. Then, the injection molding machine 10 performs a test operation, and the temperature regulator controller 713 performs control to lower the set temperature T1ref of the temperature regulator 830 (step S107). The test operation includes repeated manufacturing of molded articles, as in a mass production operation. The details of step S107 will be described later.

In the case where the temperature T1 of the temperature regulator 830 is equal to the first set temperature T1ref_start (YES in step S106), the control device 700 may perform control to notify that the preparation for the test operation is completed. The control device 700 may start the test operation upon a user's input of a command to the operation device 750. The molding conditions of a test operation and the molding conditions of a mass production operation may be the same or different. The molded article obtained in the test operation is basically discarded, but it is also possible to adopt a molded article that has passed the inspection as a product.

Next, the temperature regulator controller 713 checks whether the temperature T1ref of the temperature regulator 830 has become equal to the second set temperature T1ref_final (step S108). Step S107 is repeated until the set temperature T1ref of the temperature regulator 830 becomes equal to the second set temperature T1ref_final.

In the case where the set temperature T1ref of the temperature regulator 830 is equal to the second set temperature T1ref_final (YES in step S108), the temperature of the cavity surface of the mold device 800 is stabilized at a final target temperature. Then, the injection molding machine 10 performs a mass production operation (step S109). The details of step S109 will be described later.

In the case where the set temperature T1ref of the temperature regulator 830 is equal to the second set temperature T1ref_final (YES in step S108), the control device 700 may perform control to notify that the preparation for a mass production operation is completed. The control device 700 may start a mass production operation upon a user's input of a command to the operation device 750.

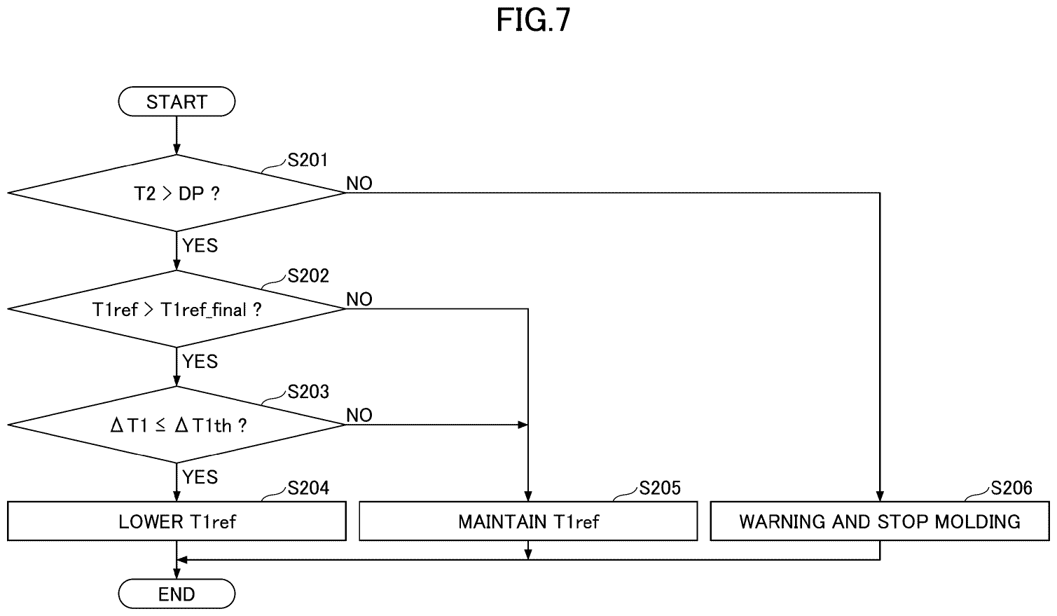

Next, referring to FIG. 7, a flowchart illustrating an example of processing performed in step S107 is explained. The process illustrated in FIG. 7 is repeatedly performed until the set temperature T1ref of the temperature regulator 830 becomes equal to the second set temperature T1ref_final. First, the temperature regulator controller 713 checks whether or not the temperature T2 of the cavity surface of the mold device 800 is higher than the dew point temperature DP (step S201).

The temperature T2 of the cavity surface of the mold device 800 is acquired by the mold temperature sensor 840 (see FIG. 3). The mold temperature sensor 840 detects the temperature T2 of the cavity surface of the mold device 800 at the time of mold opening. The mold temperature sensor 840 may be a contact type or a non-contact type. An example of the non-contact temperature sensor is a radiation temperature sensor. The mold temperature sensor 840 may be fixed to the mold device 800 by a magnet or the like. The mold temperature sensor 840 detects a temperature T2 of the cavity surface and transmits an electric signal indicating the detection result to the second acquirer 714.

In the case where the temperature T2 of the cavity surface of the mold device 800 is equal to or lower than the dew point temperature DP (NO in step S201), it is determined that condensation has occurred on the cavity surface, and therefore the control device 700 performs control to issue a warning and performs control to stop a molding operation of the injection molding machine 10 (step S206). It is also acceptable for only a warning to be issued without stopping the molding operation. The notification of the warning is performed by displaying an image, outputting a sound, outputting an alarm, or the like. A user who has received a warning may select whether or not to stop a molding operation of the injection molding machine 10.

In the case where the temperature T2 of the cavity surface of the mold device 800 is higher than the dew point temperature DP (YES in step S201), it is checked whether the set temperature T1ref of the temperature regulator 830 is higher than the second set temperature T1ref_final (step S202). In the case where the set temperature T1ref of the temperature regulator 830 becomes equal to the second set temperature T1ref_final (NO in step S202), the set temperature T1ref of the temperature regulator 830 does not need to be lowered, and thus the temperature regulator controller 713 maintains the set temperature T1ref of the temperature regulator 830 (step S205).

In the case where the set temperature T1ref of the temperature regulator 830 is higher than the second set temperature T1ref_final (YES in step S202), there is room to lower the set temperature T1ref of the temperature regulator 830, and thus it is checked whether or not the difference ΔT1 between the past temperature T1 and the current temperature T1 of the temperature regulator 830 is equal to or less than a threshold value ΔTith (step S203). Herein, ΔT1 is a difference between the past temperature T1 and the current temperature T1. The past temperature T1 and the current temperature T1 are measured with a predetermined time difference, for example. Since the control for lowering the temperature T1 is being performed, the past temperature T1 is usually equal to or higher than the current temperature T1. ΔT1 may be an absolute value.

In the case where ΔT1 is larger than the threshold value ΔTith (NO in step S203), the temperature T1 of the temperature regulator 830 is not stabilized, and thus the temperature regulator controller 713 maintains the set temperature T1ref of the temperature regulator 830 (step S205). In the case where ΔT1 is equal to or less than ΔTith (YES in step S203) on the other hand, the temperature T1 of the temperature regulator 830 is stabilized, and thus the temperature regulator controller 713 lowers the set temperature T1ref of the temperature regulator 830 (step S204).

When the set temperature T1ref of the temperature regulator 830 is lowered, the feedback control is performed, and thus the temperature T1 of the temperature regulator 830 is also lowered. The control method is not particularly limited. For example, the temperature T1 of the temperature regulator 830 can be lowered by correcting a deviation in the feedback control.

As described above, the temperature regulator controller 713 checks whether or not at least one (all in the present embodiment) of the following (1) to (3) is satisfied in the process of performing control of lowering the set temperature T1ref of the temperature regulator 830 from the first set temperature T1ref_start to the second set temperature T1ref_final. In the case where at least one (all in the present embodiment) of the following (1) to (3) is satisfied, the temperature regulator controller 713 lowers the set temperature T1ref of the temperature regulator 830.

(1) The temperature T2 of the cavity surface of the mold device 800 is higher than the dew point temperature DP (YES in step S201). (2) The set temperature T1ref of the temperature regulator 830 is higher than the second set temperature T1ref_final (YES in step S202). (3) The temperature difference ΔT1 between the past and current temperatures of the temperature regulator 830 is equal to or less than the reference value ΔT1th (YES in step S203).

In the case where at least one (all in the present embodiment) of the above (1) to (3) is satisfied, the temperature regulator controller 713 lowers the set temperature T1ref of the temperature regulator 830. Thus, the set temperature T1ref of the temperature regulator 830 can be automatically and appropriately lowered from the first set temperature T1ref_start to the second set temperature T1ref_final, regardless of the skill of a user of the injection molding machine 10.

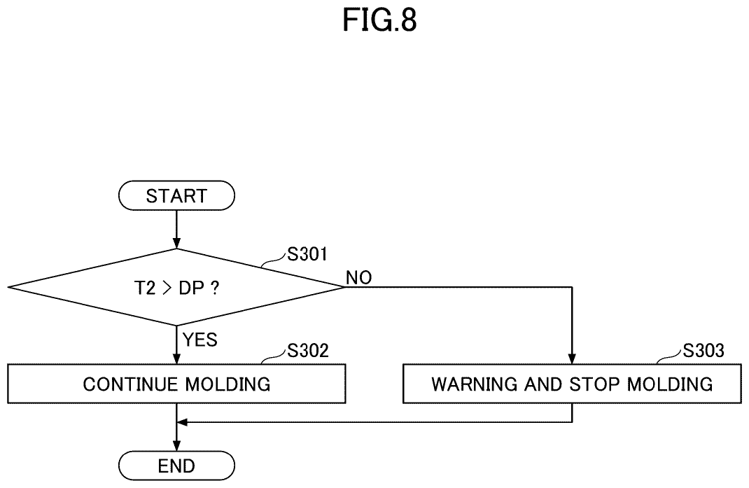

Next, referring to FIG. 8, a flowchart illustrating an example of processing performed in step S109 is explained. The process illustrated in FIG. 8 is repeatedly performed, for example, until the number of manufactured molded articles reaches a target value during a mass production operation. First, the temperature regulator controller 713 checks whether or not the temperature T2 of the cavity surface of the mold device 800 is higher than the dew point temperature DP (step S301).

In the case where the temperature T2 of the cavity surface of the mold device 800 is equal to or lower than the dew point temperature DP (NO in step S301), it is determined that condensation has occurred on the cavity surface, and therefore the control device 700 performs control to issue a warning and performs control to stop a molding operation of the injection molding machine 10 (step S303). It is also acceptable for only a warning to be issued without stopping the molding operation.

If the temperature T2 of the cavity surface of the mold device 800 is higher than the dew point temperature DP (YES in step S301), no condensation occurs on the cavity surface, and thus the control device 700 performs control to continue the molding operation of the injection molding machine 10 (step S302).

According to the present embodiment, the control device 700 monitors whether a temperature T2 of the cavity surface is higher than a dew point temperature DP during a mass production operation. Thus, it is possible to suppress a repeated manufacture of defective products in a state where dew condensation occurs on the cavity surface during mass production operation and mold release failure occurs. Furthermore, when dew condensation occurs on the cavity surface during the mass production operation, the maintenance of the mold device 800 can be quickly performed.

The embodiments of the control device for an injection molding machine, the injection molding machine, and the control method for an injection molding machine according to the present disclosure have been described above, but the present disclosure is not limited to the above-described embodiments and the like. Various changes, modifications, substitutions, additions, deletions, and combinations can be made within the scope of the claims. Such modifications are also included in the technical scope of the present disclosure.

What is claimed is:

1. A control device for an injection molding machine configured to fill a cavity space inside a mold device with a molding material, the control device comprising:
a memory;
a processor coupled to the memory; and
a temperature regulator controller configured to control a temperature regulator configured to regulate a temperature of the mold device, wherein
the temperature regulator controller controls the temperature regulator based on a dew point temperature of a surface of the mold device, the surface forming the cavity space in the mold device.

2. The control device for an injection molding machine according to claim 1, further comprising:
a first acquirer configured to acquire a temperature and a humidity of a surrounding atmosphere of the injection molding machine; and
an estimator configured to estimate the dew point temperature of the surface of the mold device based on the temperature and the humidity acquired by the first acquirer, wherein
the temperature regulator controller is configured to control the temperature regulator based on the dew point temperature estimated by the estimator.

3. The control device for an injection molding machine according to claim 1, wherein
the temperature regulator controller is configured to perform control to lower a set temperature of the temperature regulator from a first set temperature to a second set temperature in a process in which the injection molding machine repeatedly performs manufacturing of a molded article,
the first set temperature is higher than the second set temperature and higher than the dew point temperature, and
the second set temperature is lower than a temperature of a surrounding atmosphere of the injection molding machine.

4. The control device for an injection molding machine according to claim 3, further comprising:
a second acquirer configured to acquire a temperature of the surface of the mold device, wherein
the temperature regulator controller performs control to lower the set temperature of the temperature regulator in a case where the temperature of the surface of the mold device is higher than the dew point temperature.

5. The control device for an injection molding machine according to claim 3, wherein
the temperature regulator controller performs control to lower the set temperature of the temperature regulator in a case where the set temperature of the temperature regulator is higher than the second set temperature.

6. The control device for an injection molding machine according to claim 3, wherein
the temperature regulator controller performs control to lower a set temperature of the temperature regulator in a case where a temperature difference between a past temperature and a current temperature of the temperature regulator is equal to or less than a threshold value.

7. An injection molding machine comprising:
the control device of claim 1.

8. A control method for an injection molding machine configured to fill a cavity space inside a mold device with a molding material, the control method comprising:
controlling the injection molding machine;
controlling a temperature regulator configured to regulate a temperature of the mold device; and
controlling the temperature regulator based on a dew point temperature of a surface of the mold device, the surface forming the cavity space in the mold device.
